(19) United States
(12) Patent Application Publication
(10) Pub. No.: US 2025/0264973 A1
(43) Pub. Date: Aug. 21, 2025

(54) CONTEXTUAL INTERFACES FOR 3D ENVIRONMENTS

(71) Applicant: Apple Inc., Cupertino, CA (US)

(72) Inventors: Vicki M Murley, Pacifica, CA (US); Etienne Segonzac, Paris (FR); Timothy P Horton, San Jose, CA (US); Dean Jackson, Yass (AU); Chelsea E Pugh, San Francisco, CA (US)

(21) Appl. No.: 19/045,641

(22) Filed: Feb. 5, 2025

Related U.S. Application Data
(60) Provisional application No. 63/555,620, filed on Feb. 20, 2024.

(51) Int. Cl. G06F 3/04815; G06F 3/01; G06T 17/00

(52) U.S. Cl. CPC G06F 3/04815; G06F 3/013; G06T 17/00

(57) ABSTRACT

Devices, systems, and methods that interpret user activity as user interactions with virtual elements positioned within a three-dimensional (3D) space, such as an extended reality (XR) environment. For example, an example process may include presenting a view of a 3D environment with user interface elements. The process may further include obtaining first data that identifies a type of at least a portion of a user interface element of the one or more user interface elements. The process may further include determining an interface for display proximate to the user interface element, the interface including one or more controls for controlling functionality of the user interface element, and the interface is determined based on a viewpoint position of the view and the first data. The process may further include updating the view of the 3D environment to include the interface positioned proximate to the user interface element.

### CROSS-REFERENCE TO RELATED APPLICATIONS

This Application claims the benefit of U.S. Provisional Application Ser. No. 63/555,620 filed Feb. 20, 2024, which is incorporated herein in its entirety.

### TECHNICAL FIELD

The present disclosure generally relates to systems, methods, and devices that enable assessing user interactions with user interface elements of a user interface of an electronic device to configure control interfaces.

### BACKGROUND

It may be desirable to detect movement and interactions associated with icons of a user interface while a user is using a device, such as a head mounted device (HMD). However, existing systems may not provide adequate control interfaces for a user to interact with one or more user interface elements.

### SUMMARY

Various implementations disclosed herein include devices, systems, and methods that interpret user activity as user interacts with virtual elements (e.g., user interface elements) positioned within in a three-dimensional (3D) space such as an extended reality (XR) environment. Some implementations utilize an architecture that receives application user interface geometry in a system or shared simulation area and outputs data (e.g., less than all user activity data) for an application to use to recognize input. An operating system (OS) process may be configured to provide an input support process to support recognizing input intended for one or more separately-executing applications, for example, by providing some input recognition tasks to recognize user activity as input for the applications or by converting user activity data into a format that can be more easily, accurately, efficiently, or effectively interpreted by the applications and/or in a way that facilitates preservation of user privacy. The OS process may include a simulation process that utilizes application user interface information to provide 3D information (e.g., 3D world data) used by the input support process to support recognizing input intended for the one or more separate (e.g., separately executing) applications.

Various implementations disclosed herein generates and displays a customized contextual interface (e.g., a control window) on a two-dimensional (2D) webpage viewed in an XR environment using a 3D display device (e.g., a wearable device such as a head-mounted device (HMD)). For example, the contextual interface may present controls and information related to a window, without crowding or obscuring the window's contents. The contextual interface may be interacted with based on a user's intent (attention) directed at the interface. The goal is to provide easier-to-use virtual controls for a 2D webpage when displayed in a 3D environment (e.g., when the controls may be too small for gaze interaction).

Various implementations disclosed herein may provide a method that customizes and/or updates the contextual interface (e.g., a control window) based on graphical display data associated with the 2D webpage. For example, if the user is watching a webpage that displays several videos, a media player interface may be presented to the user. If the user is browsing a webpage that displays several different pages of text displays, an information interface may be displayed that lets a user navigate to various portions of the page (e.g., a quick link table of contents).

In some implementations, the contextual interface may be updated based on a determined type of image shown. For example, if the visual display is a panoramic display, then the contextual interface may match the panoramic shape, or if the 2D webpage is show in stereo, then the contextual interface may also be displayed with stereo effects, etc. In some implementations, updating/customizing the contextual interface may be based on a machine learned algorithm to understand a type of page and/or content that is being displayed, and then segment the webpage into meaningful categories that can be quickly viewed by the user based on directing his or her attention (e.g., gaze or point) at one of those subcategories.

In some implementations, the user's intent may be based on determining that a user attention direction is towards the contextual interface based on sensor data. For example, the user-based data may include gaze data, hands data, head data, etc., or other input data (e.g., data from an input controller).

User privacy may be preserved by only providing some user activity information to the webpages or separately-executed applications, e.g., withholding user activity information that is not associated with intentional user actions such as user actions that are intended by the user to provide input or certain types of input. In one example, raw hands and/or gaze data may be excluded from the data provided to the webpages or applications such that webpages or applications receive limited or no information about where the user is looking or what the user is looking at times when there is no intentional user interface interaction.

In general, one innovative aspect of the subject matter described in this specification can be embodied in methods that include the actions of, at an electronic device having a processor, presenting a view of a three-dimensional (3D) environment, wherein one or more user interface elements are positioned at 3D positions based on a 3D coordinate system associated with the 3D environment. The actions may further include obtaining first data associated with the one or more user interface elements, the first data identifying a type of at least a portion of a user interface element of the one or more user interface elements. The actions may further include determining an interface for display proximate to the user interface element, the interface including one or more controls for controlling functionality of the user interface element, wherein the interface is determined based on a viewpoint position of the view and the first data. The actions may further include updating the view of the 3D environment to include the interface positioned proximate to the user interface element.

These and other embodiments may each optionally include one or more of the following features.

In some aspects, the one or more controls enable control of one or more portions of the user interface element. In some aspects, the interface is anchored to a surface of the user interface element.

In some aspects, the at least a portion of the user interface element includes a panoramic image, the type of the at least a portion of the user interface element is a panoramic image type, and the interface is determined based on the panoramic image type.

In some aspects, the at least a portion of the user interface element includes stereoscopic image pairs including left eye content corresponding to a left eye viewpoint and right eye content corresponding to a right eye viewpoint, the type of the at least a portion of the user interface element is a stereoscopic image type, and the interface is determined based on the stereoscopic image type.

In some aspects, the actions may further include determining one or more attributes associated with the user interface element, wherein determining the interface includes determining one or more attributes associated with the interface based on the determined one or more attributes associated with the user interface element.

In some aspects, obtaining the first data associated with the one or more user interface elements includes determining a type of content associated with each user interface element of the one or more user interface elements, and determining a category for each user interface element based on the determined type of content associated with each user interface element, wherein the interface is determined based on the determined category for the first data.

In some aspects, determining the type of content associated with each user interface element is based on using a machine learning classifier model to identify one or more types of content associated with each user interface element and segment the one or more types of content to an associated category.

In some aspects, the actions may further include removing the interface from the view of the 3D environment in response to determining that the user interface element includes control elements that satisfy one or more criterion.

In some aspects, the actions may further include receiving data corresponding to user activity associated with the one or more controls of the interface; and updating the user interface element based on the user activity. In some aspects, the data corresponding to the user activity is obtained via one or more sensors on the electronic device. In some aspects, the data corresponding to the user activity includes gaze data including a stream of gaze vectors corresponding to gaze directions over time during use of the electronic device. In some aspects, the data corresponding to the user activity includes hands data including a hand pose skeleton of multiple joints for each of multiple instants in time during use of the electronic device. In some aspects, the data corresponding to the user activity includes hands data and gaze data.

In some aspects, the 3D environment is an extended reality (XR) environment. In some aspects, the electronic device is a head-mounted device (HMD).

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A-1B illustrate exemplary electronic devices operating in a physical environment in accordance with some implementations.

FIG. 2 illustrates views, provided via a device, of user interface elements within the 3D physical environment of FIGS. 1A-1B in which the user performs interactions in accordance with some implementations.

FIG. 3 illustrates a view, provided via a device, of user interface elements within the 3D physical environment of FIGS. 1A-1B in which the user performs an interaction in accordance with some implementations.

FIG. 4 illustrates an example of tracking movements of hands and gaze during an interaction, in accordance with some implementations.

FIG. 5 illustrates a view of an extended reality (XR) environment provided by the electronic device of FIGS. 1A or 1B, in accordance with some implementations.

FIGS. 6A and 6B illustrate views of an example of interaction recognition of user activity and displaying a control interface for a user interface that may be controlled by user interaction, in accordance with some implementations.

FIGS. 7A and 7B illustrate views of an example of interaction recognition of user activity and displaying a control interface for a user interface element that may be controlled by user interaction, in accordance with some implementations.

FIGS. 8A and 8B illustrate views of an example of interaction recognition of user activity and displaying a control interface for a user interface element that may be controlled by user interaction, in accordance with some implementations.

FIG. 9 illustrates use of an exemplary input support framework to generate interaction data based on hands and gaze data and user interface target data, in accordance with some implementations.

FIG. 10 illustrates an example of configuring and displaying a control interface for a user interface element that may be controlled by user interaction, in accordance with some implementations.

FIG. 11 is a flowchart illustrating a method for providing an interface positioned on a surface of a user interface element that includes controls for controlling functionality of the user interface element, in accordance with some implementations.

FIG. 12 is a block diagram of an electronic device of in accordance with some implementations.

FIG. 13 is a block diagram of an exemplary head-mounted device, in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

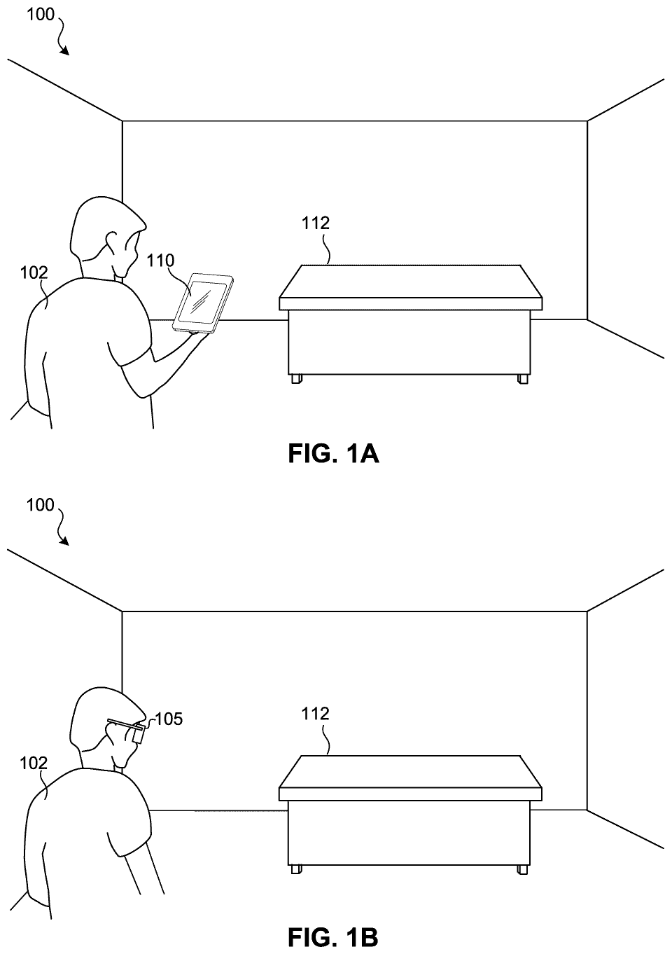

FIGS. 1A-1B illustrate exemplary electronic devices 105 and 110 operating in a physical environment 100. In the example of FIGS. 1A-1B, the physical environment 100 is a room that includes a desk 112. The electronic devices 105 and 110 may include one or more cameras, microphones, depth sensors, or other sensors that can be used to capture information about and evaluate the physical environment 100 and the objects within it, as well as information about the user 102 of electronic devices 105 and 110. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic devices 105 (e.g., a wearable device such as an HMD) and/or 110 (e.g., a handheld device such as a mobile device, a tablet computing device, a laptop computer, etc.). Such an XR environment may include views of a 3D environment seen through a transparent or translucent display or a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system (e.g., a 3D space) associated with the XR environment, which may correspond to a 3D coordinate system of the physical environment 100.

In some implementations, video (e.g., pass-through video depicting a physical environment) is received from an image sensor of a device (e.g., device 105 or device 110). In some implementations, a 3D representation of a virtual environment is aligned with a 3D coordinate system of the physical environment. A sizing of the 3D representation of the virtual environment may be generated based on, inter alia, a scale of the physical environment or a positioning of an open space, floor, wall, etc. such that the 3D representation is configured to align with corresponding features of the physical environment. In some implementations, a viewpoint within the 3D coordinate system may be determined based on a position of the electronic device within the physical environment. The viewpoint may be determined based on, inter alia, image data, depth sensor data, motion sensor data, etc., which may be retrieved via a virtual inertial odometry system (VIO), a simultaneous localization and mapping (SLAM) system, etc.

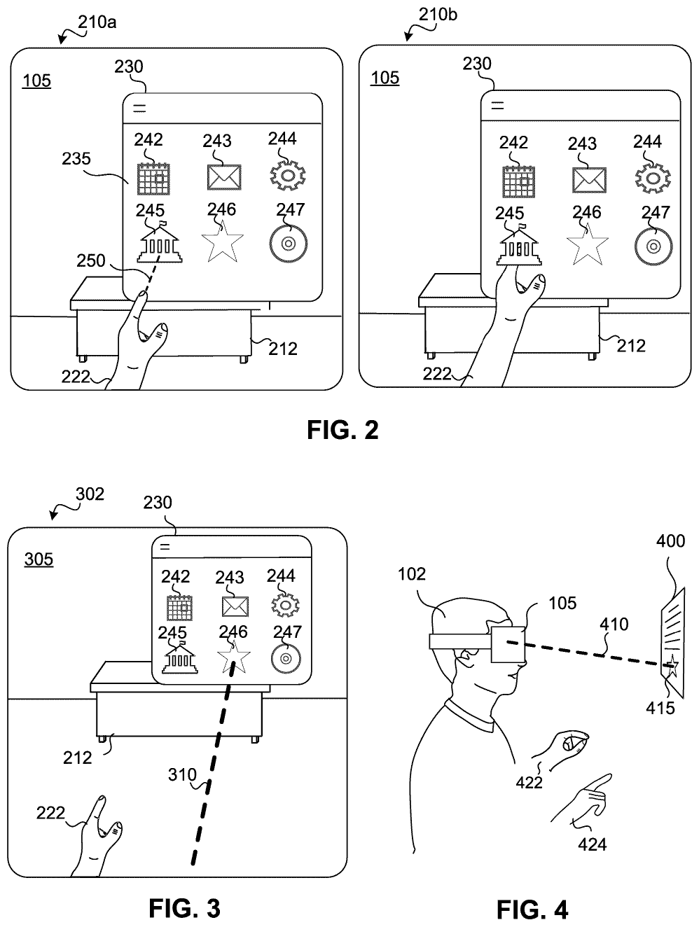

FIG. 2 illustrates views, provided via a device, of user interface elements within the 3D physical environment of FIGS. 1A-1B, in which the user performs an interaction (e.g., a direct interaction). In this example, the user 102 makes a hand gesture relative to content presented in views 210a-b of an XR environment provided by a device (e.g., device 105 or device 110). The views 210a-b of the XR environment include an exemplary user interface 230 of an application (e.g., an example of virtual content) and a representation 212 of the desk 112 (e.g., an example of real content). Providing such a view may involve determining 3D attributes of the physical environment 100 and positioning the virtual content, e.g., user interface 230, in a 3D coordinate system corresponding to that physical environment 100.

In the example of FIG. 2, the user interface 230 includes various content user interface elements, including a background portion 235 and user interface elements 242, 243, 244, 245, 246, 247. The user interface elements 242, 243, 244, 245, 246, 247 may be displayed on the flat two-dimensional (2D) user interface 230. The user interface 230 may be a user interface of an application, as illustrated in this example. In some implementations, an indicator (e.g., a pointer, a highlight structure, etc.) may be used for indicating a point of interaction with any of user interface (visual) elements (e.g., if using a controller device, such as a mouse or other input device). The user interface 230 is simplified for purposes of illustration and user interfaces in practice may include any degree of complexity, any number of content items, and/or combinations of 2D and/or 3D content. The user interface 230 may be provided by operating systems and/or applications of various types including, but not limited to, messaging applications, web browser applications, content viewing applications, content creation and editing applications, or any other applications that can display, present, or otherwise use visual and/or audio content.

In this example, the background portion 235 of the user interface 230 is flat. In this example, the background portion 235 includes all aspects of the user interface 230 being displayed except for the user interface elements 242, 243, 244, 245, 246, 247. Displaying a background portion of a user interface of an operating system or application as a flat surface may provide various advantages. Doing so may provide an easy to understand or otherwise use portion of an XR environment for accessing the user interface of the application. In some implementations, multiple user interfaces (e.g., corresponding to multiple, different applications) are presented sequentially and/or simultaneously within an XR environment, e.g., within one or more colliders or other such components.

In some implementations, the positions and/or orientations of such one or more user interfaces may be determined to facilitate visibility and/or use. The one or more user interfaces may be at fixed positions and orientations within the 3D environment. In such cases, user movements would not affect the position or orientation of the user interfaces within the 3D environment.

The position of the user interface within the 3D environment may be based on determining a distance of the user interface from the user (e.g., from an initial or current user position). The position and/or distance from the user may be determined based on various criteria including, but not limited to, criteria that accounts for application type, application functionality, content type, content/text size, environment type, environment size, environment complexity, environment lighting, presence of others in the environment, use of the application or content by multiple users, user preferences, user input, and numerous other factors.

In some implementations, the one or more user interfaces may be body-locked content, e.g., having a distance and orientation offset relative to a portion of the user's body (e.g., their torso). For example, the body-locked content of a user interface could be 0.5 meters away and 45 degrees to the left of the user's torso's forward-facing vector. If the user's head turns while the torso remains static, a body-locked user interface would appear to remain stationary in the 3D environment at 2 m away and 45 degrees to the left of the torso's front facing vector. However, if the user does rotate their torso (e.g., by spinning around in their chair), the body-locked user interface would follow the torso rotation and be repositioned within the 3D environment such that it is still 0.5 meters away and 45 degrees to the left of their torso's new forward-facing vector.

In other implementations, user interface content is defined at a specific distance from the user with the orientation relative to the user remaining static (e.g., if initially displayed in a cardinal direction, it will remain in that cardinal direction regardless of any head or body movement). In this example, the orientation of the body-locked content would not be referenced to any part of the user's body. In this different implementation, the body-locked user interface would not reposition itself in accordance with the torso rotation. For example, a body-locked user interface may be defined to be 2 m away and, based on the direction the user is currently facing, may be initially displayed north of the user. If the user rotates their torso 180 degrees to face south, the body-locked user interface would remain 2 m away to the north of the user, which is now directly behind the user.

A body-locked user interface could also be configured to always remain gravity or horizon aligned, such that head and/or body changes in the roll orientation would not cause the body-locked user interface to move within the 3D environment. Translational movement would cause the body-locked content to be repositioned within the 3D environment in order to maintain the distance offset.

In the example of FIG. 2, the user 102 moves their hand from an initial position as illustrated by the position of the representation 222 in view 210a. The hand moves along path 250 to a later position as illustrated by the position of the representation 222 in the view 210b. As the user 102 moves their hand along this path 250, the finger intersects the user interface 230. Specifically, as the finger moves along the path 250, it virtually pierces the user interface element 245 and thus a tip portion of the finger (not shown) is occluded in view 210b by the user interface 230.

Implementations disclosed herein interpret user movements such as the user 102 moving their hand/finger along path 250 relative to a user interface element such as user interface element 245 to recognize user input/interactions. The interpretation of user movements and other user activity may be based on recognizing user intention using one or more recognition processes.

Recognizing input in the example of FIG. 2 may involve determining that a gesture is a direct interaction and then using a direct input recognition process to recognize the gesture. For example, such a gesture may be interpreted as a tap input to the user interface element 245. In making such a gesture, the user's actual motion relative to the user interface element 245 may deviate from an ideal motion (e.g., a straight path through the center of the user interface element in a direction that is perfectly orthogonal to the plane of the user interface element). The actual path may be curved, jagged, or otherwise non-linear and may be at an angle rather than being orthogonal to the plane of the user interface element. The path may have attributes that make it similar to other types of input gestures (e.g., swipes, drags, flicks, etc.) For example, the non-orthogonal motion may make the gesture similar to a swipe motion in which a user provides input by piercing a user interface element and then moving in a direction along the plane of the user interface.

Some implementations disclosed herein determine that a direct interaction mode is applicable and, based on the direct interaction mode, utilize a direct interaction recognition process to distinguish or otherwise interpret user activity that corresponds to direct input, e.g., identifying intended user interactions, for example, based on if, and how, a gesture path intercepts one or more 3D regions of space. Such recognition processes may account for actual human tendencies associated with direct interactions (e.g., natural arcing that occurs during actions intended to be straight, tendency to make movements based on a shoulder or other pivot position, etc.), human perception issues (e.g., user's not seeing or knowing precisely where virtual content is relative to their hand), and/or other direct interaction-specific issues.

Note that the user's movement in the real world (e.g., physical environment 100) correspond to movements within a 3D space, e.g., an XR environment that is based on the real-world and that includes virtual content such as user interface positioned relative to real-world objects including the user. Thus, the user is moving his hand in the physical environment 100, e.g., through empty space, but that hand (e.g., a depiction or representation of the hand) intersects with and/or pierces through the user interface 300 of the XR environment that is based on that physical environment. In this way, the user virtually interacts directly with the virtual content.

FIG. 3 illustrates an exemplary view, provided via a device, of user interface elements within the 3D physical environment of FIGS. 1A-1B in which the user performs an interaction (e.g., an indirect interaction based on gaze and pointing). In this example, the user 102 makes a hand gesture while looking at content presented in the view 302 of an XR environment provided by a device (e.g., device 105 or device 110). The view 302 of the XR environment includes the exemplary user interface 230 FIG. 2. In the example of FIG. 3, the user 102 makes a pointing gesture with their hand as illustrated by the representation 222 while gazing along gaze direction 310 at user interface icon 246 (e.g., a star shaped application icon or widget). In this example, this user activity (e.g., a pointing hand gesture along with a gaze at a user interface element) corresponds to a user intention to interact with user interface icon 246, e.g., the point signifies a potential intention to interact and the gaze (at the point in time of the point) identifies the target of the interaction (e.g., waiting for the system to highlight the icon to indicate to the user of the correct target before initiating an interaction from another user activity, such as via a pinch gesture).

Implementations disclosed herein interpret user activity, such as the user 102 with a pointing hand gesture along with a gaze at a user interface element, to recognize user interactions. For example, such user activity may be interpreted as a tap input to the user interface element 246, e.g., selecting user interface element 246. However, in performing such actions, the user's gaze direction and/or the timing between a gesture and gaze with which the user intends the gesture to be associated may be less than perfectly executed and/or timed.

Some implementations disclosed herein determine that an indirect interaction mode is applicable and, based on the indirect interaction mode, utilize an indirect interaction recognition process to identify intended user interactions based on user activity, for example, based on if, and how, a gesture path intercepts one or more 3D regions of space. Such recognition processes may account for actual human tendencies associated with indirect interactions (e.g., eye saccades, eye fixations, and other natural human gaze behavior, arching hand motion, retractions not corresponding to insertion directions as intended, etc.), human perception issues (e.g., user's not seeing or knowing precisely where virtual content is relative to their hand), and/or other indirect interaction-specific issues.

Some implementations determine an interaction mode, e.g., a direct interaction mode or indirect interaction mode, so that user behavior can be interpreted by a specialized (or otherwise separate) recognition process for the appropriate interaction type, e.g., using a direct interaction recognition process for direct interactions and an indirect interaction recognition process or indirect interactions. Such specialized (or otherwise separate) process utilization may be more efficient, more accurate, or provide other benefits relative to using a single recognition process configured to recognize multiple types (e.g., both direct and indirect) interactions.

FIGS. 2 and 3 illustrate example interaction modes that are based on user activity within a 3D environment. Other types or modes of interaction may additionally or alternatively be used including but not limited to user activity via input devices such as keyboards, trackpads, mice, hand-held controllers, and the like. In one example, a user provides an interaction intention via activity (e.g., performing an action such as tapping a button or a trackpad surface) using an input device such as a keyboard, trackpad, mouse, or hand-held controller and a user interface target is identified based on the user's gaze direction at the time of the input on the input device. Similarly, user activity may involve voice commands. In one example, a user provides an interaction intention via activity (e.g., performing an action such as tapping a button or a trackpad surface) using an input device such as a keyboard, trackpad, mouse, or hand-held controller and a user interface target is identified based on the user's gaze direction at the time of the voice command. In another example, user activity identifies an intention to interact (e.g., via a pinch, hand gesture, voice command, input-device input, etc.) and a user interface element is determined based on a non-gaze-based direction, e.g., based on where the user is pointing within the 3D environment. For example, a user may pinch with one hand to provide input indicating an intention to interact while pointing at a user interface button with a finger of the other hand. In another example, a user may manipulate the orientation of a hand-held device in the 3D environment to control a controller direction (e.g., a virtual line extending from controller within the 3D environment) and a user interface element with respect to which the user is interacting may be identified based on the controller direction, e.g., based on identifying what user interface element the controller direction intersects with when input indicating an intention to interact is received.

Various implementations disclosed herein provide an input support process, e.g., as an OS process separate from an executing application, that processes user activity data (e.g., regarding gaze, hand gestures, other 3D activities, HID inputs, etc.) to produce data for an application that the application can interpret as user input. The application may not need to have 3D input recognition capabilities, as the data provided to the application may be in a format that the application can recognize using 2D input recognition capabilities, e.g., those used within application developed for use on 2D touch-screen and/or 2D cursor-based platforms. Accordingly, at least some aspects of interpreting user activity for an application may be performed by processes outside of the application. Doing so may simplify or reduce the complexity, requirements, etc. of the application's own input recognition processes, ensure uniform, consistent input recognition across multiple, different applications, protect private use data from application access, and numerous other benefits as described herein.

FIG. 4 illustrates an exemplary interaction tracking the movements of two hands 422, 424 of the user 102, and a gaze along the path 410, as the user 102 is virtually interacting with a user interface element 415 of a user interface 400. In particular, FIG. 4 illustrates an interaction with user interface 400 as the user is facing the user interface 400. In this example, the user 102 is using device 105 to view and interact with an XR environment that includes the user interface 400. An interaction recognition process (e.g., direct or indirection interaction) may use sensor data and/or user interface information to determine, for example, which user interface element the user's hand is virtually touching, which user interface element the user intends to interact with, and/or where on that user interface element the interaction occurs. Direct interaction may additionally (or alternatively) involve assessing user activity to determine the user's intent, e.g., did the user intend to a straight tap gesture through the user interface element or a sliding/scrolling motion along the user interface element. Additionally, recognition of user intent may utilize information about the user interface elements. For example, determining user intent with respect to user interface elements may include the positions, sizing, and type of element, types of interactions that are capable on the element, types of interactions that are enabled on the element, which of a set of potential target elements for a user activity accepts which types of interactions, and the like.

Various two-handed gestures may be enabled based on interpreting hand positions and/or movements using sensor data, e.g., image or other sensor data captured by outward facing sensors on an HMD, such as device 105. For example, a pan gesture may be performed by pinching both hands and then moving both hands in the same direction, e.g., holding the hands out at a fixed distance apart from one another and moving them both an equal amount to the right to provide input to pan to the right. In another example, a zoom gesture may be performed by holding the hands out and moving one or both hands to change the distance between the hands, e.g., moving the hands closer to one another to zoom in and farther from one another to zoom out.

Additionally, or alternatively, in some implementations, recognition of such an interaction of two hands may be based on functions performed both via a system process and via an application process. For example, an OS's input support process may interpret hands data from the device's sensors to identify an interaction event and provide limited or interpreted information about the interaction event to the application that provided the user interface 400. For example, rather than providing detailed hand information (e.g., identifying the 3D positions of multiple joints of a hand model representing the configuration of the hand 422 and hand 424), the OS input support process may simply identify a 2D point within the 2D user interface 400 on the user interface element 415 at which the interaction occurred, e.g., an interaction pose. The application process can then interpret this 2D point information (e.g., interpreting it as a selection, mouse-click, touch-screen tap, or other input received at that point) and provide a response, e.g., modifying its user interface accordingly.

In some implementations, hand motion/position may be tracked using a changing shoulder-based pivot position that is assumed to be at a position based on a fixed offset from the device's 105 current position. The fixed offset may be determined using an expected fixed spatial relationship between the device and the pivot point/shoulder. For example, given the device's 105 current position, the shoulder/pivot point may be determined at position X given that fixed offset. This may involve updating the shoulder position over time (e.g., every frame) based on the changes in the position of the device over time. The fixed offset may be determined as a fixed distance between a determined location for the top of the center of the head of the user 102 and the shoulder joint.

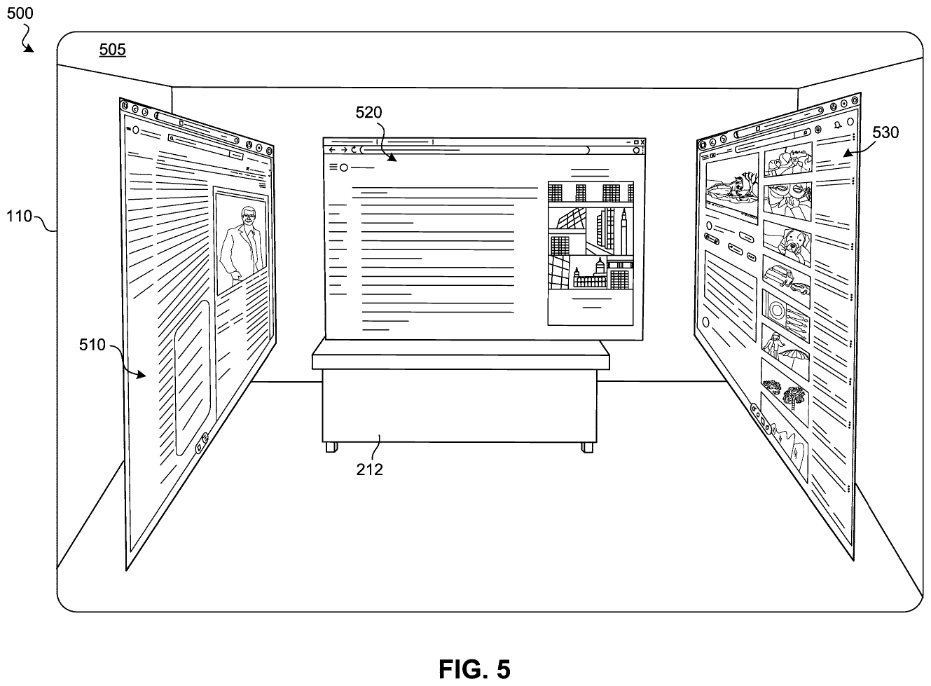

FIG. 5 illustrates a view 500 of an XR environment 505 provided by the electronic device 110 or electronic device 105 of FIGS. 1A-1B in accordance with some implementations. FIG. 5 includes a representation 212 of desk 112 (e.g., a representation of a physical object that may be viewed as pass-through video or may be a direct view of the physical object through a transparent or translucent display). Additionally, FIG. 5 includes exemplary user interfaces 510, 520, 530, of one or more applications (e.g., an immersive display of three window applications such as 2D webpages viewed using a 3D device). Providing such a view 500 may involve determining 3D attributes of the physical environment 100 and positioning virtual content, e.g., user interfaces 510, 520, and/or 530 in a 3D coordinate system corresponding to that physical environment 100.

In the example of FIG. 5, the user interfaces 510, 520, 530 include various content items, including background portions, application portions, and one or more control elements (e.g., selectable icons). The user interfaces 510, 520, 530 are simplified for purposes of illustration and user interfaces in practice may include any degree of complexity, any number of content items, and/or combinations of 2D and/or 3D content. The user interfaces 510, 520, 530 may be provided by operating systems and/or applications of various types including, but not limited to, messaging applications, web browser applications, content viewing applications, content creation and editing applications, or any other applications that can display, present, or otherwise use visual and/or audio content.

FIG. 5 provides a view 500 of a 3D environment (e.g., XR environment 505) by rasterizing vector graphics (e.g., text) on separated 2D assets (e.g., separate windows, such as user interfaces 510, 520, and 530) within the 3D environment and then rendering a view of the 3D environment (e.g., view 500 of XR environment 505). The separated 2D assets may be windows (e.g., separate windows, such as user interfaces 510, 520, and 530), but may be other virtual/content elements such as buttons, etc., and may be defined as spatially-separated layers in a hierarchical drawing commands framework. The vector graphics may be rasterized to account for human vision fall-off from gaze direction (e.g., avoiding over-sampling and undersampling) by using scale factors (e.g., based on target resolutions) and may be illustrated by a gaze direction visualization map.

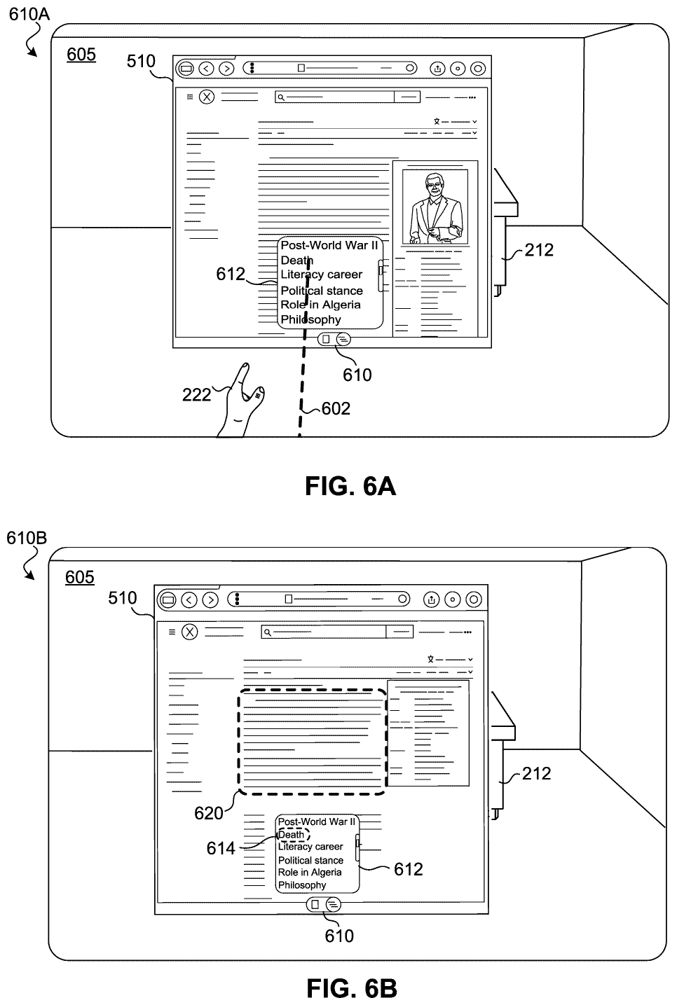

FIGS. 6A, 6B, 7A, 7B, 8A, and 8B illustrate different examples of tracking user activity (e.g., viewer position data, movements of the hands, gaze, etc.) during an interaction of a user viewing a 2D webpage and attempting to perform a gesture (e.g., user's intent (attention) directed at the user interface element) in order to provide a contextual interface that is configured based on the user interface element (e.g., webpage) the user is focused on. For example, each figure illustrates configuring a contextual interface associated with a user interface that a user is directing his or her attention to (e.g., viewer position data) and tracking a portion of the user (e.g., a hand of user) using sensors (e.g., outward facing image sensors) on a head-mounted device, such as device 105 as the user is moving in the environment and interacting with an environment (e.g., an XR environment). For example, the user may be viewing an XR environment, such as XR environment 205 illustrated in FIG. 2 and/or XR environment 305 illustrated in FIG. 3, and interacting with elements within the application window of the user interface (e.g., user interface 230) as a device (e.g., device 105) tracks viewer position data, hand movements, and/or gaze of the user 102. The user activity tracking system can then determine if the user is trying to interact with the contextual interface or other portions of the user interface. The contextual interface may be virtual content that an application window can allow the user to interact with, and the user activity tracking system can determine whether the user is interacting with any particular element or performing a particular motion in a 3D coordinate space such as performing a click gesture. For example, hand representation 222 represents the user's 102 left hand as the user is looking at a user interface or a contextual interface at first instance in time and is performing a user interaction event. As the user activity indicates an interaction with a particular object (e.g., a contextual interface), the application can initiate an identified action (e.g., advance to a different portion of the webpage or video). In some implementations, the user activity tracking system can track hand movements based on the movement of one or more points as the user moves his or her hands (e.g., hand representations 222), and the application can perform actions (e.g., zoom, rotate, move, pan, etc.) based on the detected movements of the hands.

FIGS. 6A and 6B illustrate an example of interaction recognition of user activity (e.g., of user 102 of FIGS. 1A-1B) and displaying a control interface for a user interface that may be controlled by user interaction, in accordance with some implementations. FIGS. 6A and 6B are presented in views 610A and 610B, respectively, of an XR environment provided by electronic device 105 and/or electronic device 110 of FIGS. 1A-1B. The views 610A-B of the XR environment 605 includes a view of the representation 212 (e.g., desk 112) as the user 102 is interacting with user interface 510 of FIG. 5 (e.g., the user is reading the content on the webpage).

In particular, FIG. 6A illustrates view 610A of the user interface 510 that includes a contextual interface 610 that provides an index interface 612 (e.g., an interactable element that lists determined subcategories of the content associated with the user interface 510). In other words, based on the content of the webpage for user interface 510, the techniques described herein determined and analyzed the context of the webpage as an information website, and then created an index list for the user to quickly skip to different sections of the webpage. Additionally, FIG. 6A illustrates view 610A at a first instance of time of a user's 102 intent (attention) directed at the index interface 612 as illustrated by the left hand pointing (e.g., hand representation 222) and a gaze along the path 602 (e.g., the user wants to skip to the section about the death of the person he or she is reading about).

FIG. 6B illustrates view 610B, for a second instance in time, of updated web content on the user interface 510 (e.g., scrolled to a different section “death”) after the user has selected the particular section. Additionally, a graphical indication 614 is displayed to indicate to the user that he or she has selected the particular section, and is matched with the graphical indication 620 that highlights the particular section he or she wanted to read based on the determined user's 102 intent based on the user activity illustrated in FIG. 6A (e.g., intent or focus on the section or subcategory within the index interface 612). The graphical indications 614 and 620 provide a visual effect or glow that indicate the section that was selected based on the user's intent.

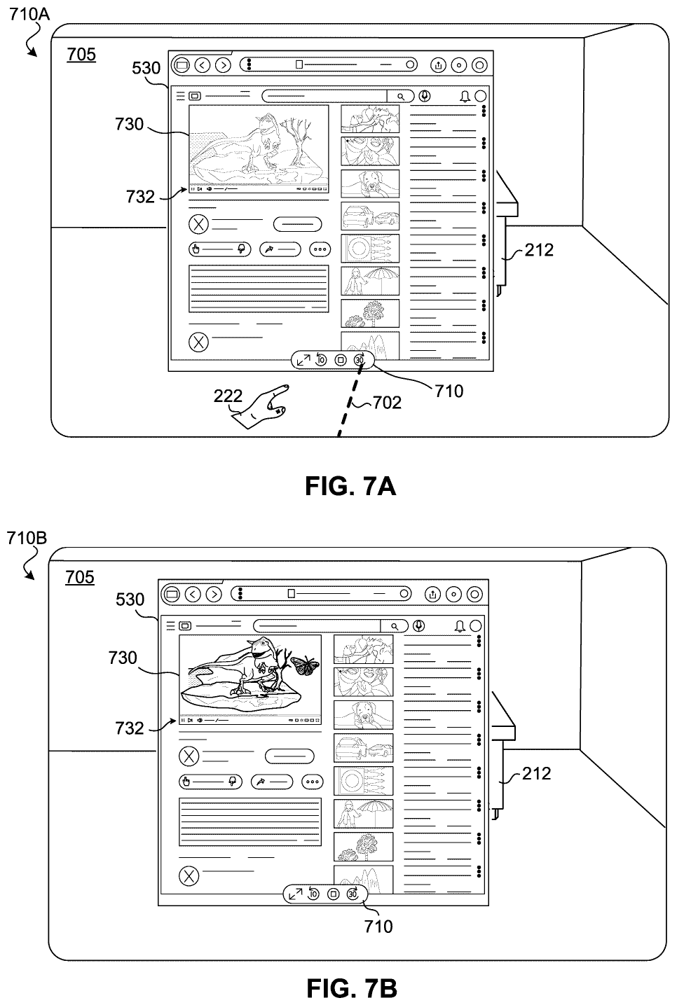

FIGS. 7A and 7B illustrate views of an example of interaction recognition of user activity (e.g., of user 102 of FIGS. 1A-1B) and displaying a control interface for a user interface element that may be controlled by user interaction, in accordance with some implementations. FIGS. 7A and 7B are presented in views 710A and 710B, respectively, of an XR environment provided by electronic device 105 and/or electronic device 110 of FIGS. 1A-1B. The views 710A-B of the XR environment 705 includes a view of the representation 212 (e.g., desk 112) as the user 102 is interacting with user interface 530 of FIG. 5 (e.g., the user is looking at a particular video 730 of a series of video content on the webpage).

In particular, FIG. 7A illustrates view 710A of the user interface 530 that includes a contextual interface 710 that provides video controls (e.g., an interactable element that provides video control elements). In other words, based on the content of the webpage for user interface 530, the techniques described herein determined and analyzed the context of the webpage as a video provider website, and then created a video control interface (contextual interface 710) for the user to more easily skip to different sections of the displayed video 730. For example, the video controls 732 for the displayed video 730 are determined to be too small for user interaction (e.g., via gaze and hands data) because the video player is displayed as a small portion in the webpage and relative to a current view, then the contextual interface 710 may be automatically displayed to aide in controlling the video. Additionally, FIG. 7A illustrates view 710A at a first instance of time of a user's 102 intent (attention) directed at the contextual interface 710 as illustrated by the left hand pointing (e.g., hand representation 222) and a gaze along the path 702 (e.g., the user wants to skip to fast forward 30 seconds in the currently playing video of the displayed video 730). FIG. 7B illustrates view 710B, for a second instance in time, of updated video content for the displayed video 730 on the user interface 530 after the user has selected the fast forward 30 seconds element (e.g., the dinosaur video has skipped ahead 30 seconds to a different portion of the video content).

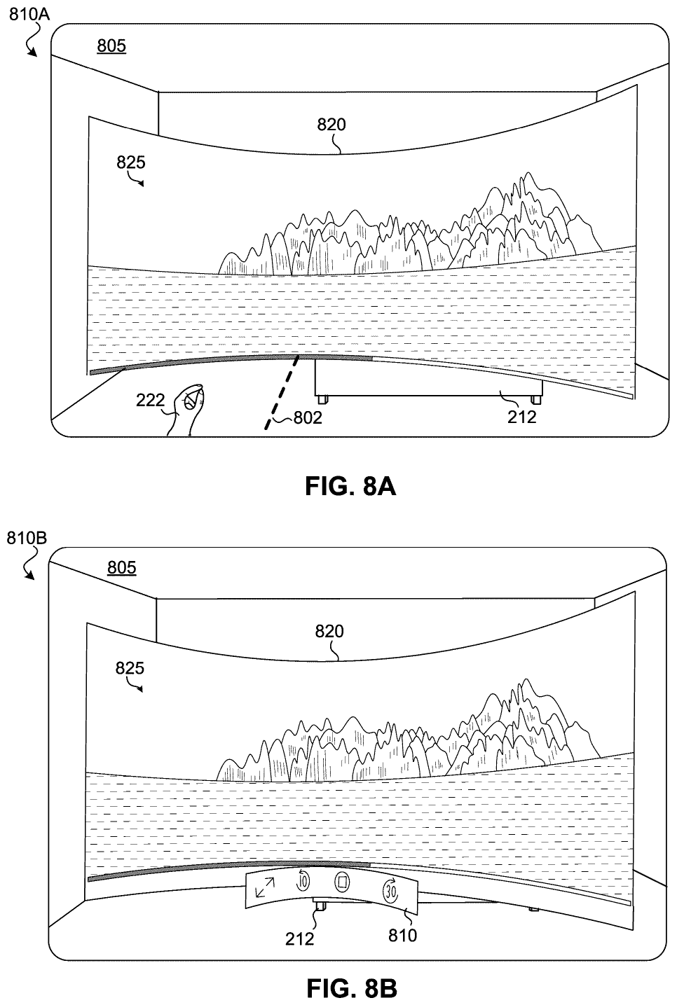

FIGS. 8A and 8B illustrate views of an example of interaction recognition of user activity (e.g., of user 102 of FIGS. 1A-1B) and displaying a control interface for a user interface element that may be controlled by user interaction, in accordance with some implementations. FIGS. 8A and 8B are presented in views 810A and 810B, respectively, of an XR environment provided by electronic device 105 and/or electronic device 110 of FIGS. 1A-1B. The views 810A-B of the XR environment 805 includes a view of the representation 212 (e.g., desk 112) as the user 102 is interacting with user interface 820 (e.g., the user is looking at a virtual panoramic video 825).

In particular, FIG. 8A illustrates view 810A of the user interface 820 at a first instance of time of a user's 102 intent (attention) directed at the virtual panoramic video 825 as illustrated by the left hand pointing (e.g., hand representation 222) and a gaze along the path 802. In other words, the user actions indicate that the user wants to be provided with video controls to control the video (e.g., pause, stop, rewind, fast forward 30 seconds, etc.) in the currently playing panoramic video 825. Thus, FIG. 8B, at a second instance in time, provides a contextual interface 810 that provides the video controls (e.g., an interactable element that provides video control elements). In other words, based on the content of the webpage for user interface 820 (virtual panoramic video 825), the techniques described herein determined and analyzed the context of the webpage as a panoramic video, and then created a panoramic video control interface (contextual interface 810 that matches the shape) for the user to more easily skip to different sections of the displayed panoramic video 825. For example, as illustrated by FIG. 8B, the contextual interface 810 is generated that appears to be in a panoramic shape, the same shape as the panoramic video being played by user interface 820. In some implementations, the user interface element includes stereoscopic image pairs including left eye content corresponding to a left eye viewpoint and right eye content corresponding to a right eye viewpoint, and the interface is determined based on the stereoscopic image pairs. Thus, if the user interface 820 converts from the panoramic display to a stereo display and a flat rectangle shape, then the contextual interface 810 may update to match as a stereo display control window and in a flat rectangle shape, and may still be anchored in the same location (e.g., bottom and centered).

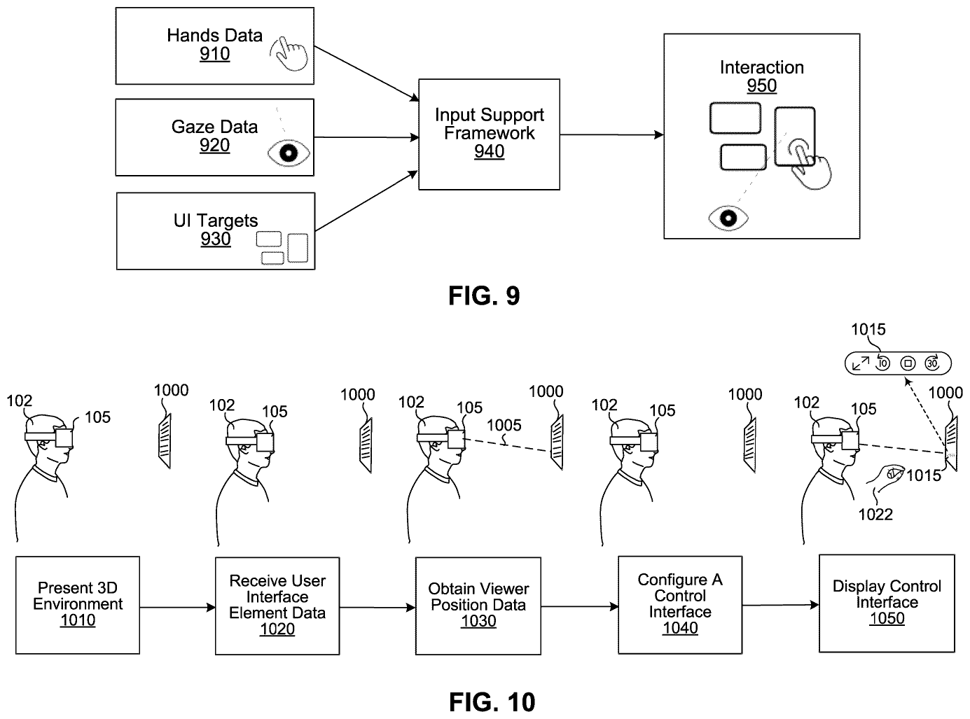

FIG. 9 illustrates use of an exemplary input support framework 940 to generate interaction data based on hands data 910, gaze data 920, and user interface target data 930 to produce interaction data 950 that can be provided to one or more applications and/or used by system processes to provide a desirable user experience. In some implementations, the input support process 940 is configured to understand a user's intent to interact, generate input signals and events to create reliable and consistent user experiences across multiple applications, detect input out-of-process and route it through the system responsibly. The input support process 940 may arbitrate which application, process, and/or user interface element should receive user input, for example, based identifying which application or user interface element is the intended target of a user activity. The input support process 940 may keep sensitive user data, e.g., gaze, hand/body enrollment data, etc., private; only sharing abstracted or high-level information with applications.

The input support process may take hands data 910, gaze data 920, and user interface target data 930 and determine user interaction states. In some implementations, it does so within a user environment in which multiple input modalities are available to the user, e.g., an environment in which a user can interact directly as illustrated in FIG. 2 or indirectly as illustrated in FIG. 3 to achieve the same interactions with user interface elements. For example, the input support process may determine that the user's right hand is performing an intentional pinch and gaze interaction with a user interface element, that the left hand is directly tapping a user interface element, or that the left hand is fidgeting and therefor idle/doing nothing relevant to the user interface. In some implementations, the user interface target data 930 includes information associated with the user interface elements, such as scalable vector graphics (SVG) information for vector graphics (e.g., may have some information from the basic shapes, paths, or may contain masks or clip paths) and/or other image data (e.g., RGB data or image metadata for bitmap images).

Based on determining a user intent to interact, the input support framework 940 may generate interaction data 950 (e.g., including an interaction pose, manipulator pose, and/or interaction state). The input support framework may generate input signals and events that applications may consume without needed custom or 3D input recognition algorithms in process. In some implementations, the input support framework provides interaction data 950 in a format that an application can consume as a touch event on a touch screen or as track pad tap with a 2D cursor at a particular position. Doing so may enable the same application (with little or no additional input recognition processes) to interpret interactions across different environments including new environment for which an application was not originally created and/or using new and different input modalities. Moreover, application responses to input may be more reliable and consistent across applications in a given environment and across different environments, e.g., enabling consistent user interface responses for 2D interactions with the application on tablets, mobile devices, laptops, etc. as well as for 3D interactions with the application on an HMD and/or other 3D/XR devices.

The input support framework may also manage user activity data such that different applications are not aware of user activity relevant to other applications, e.g., one application will not receive user activity information while a user types a password into another app. Doing so may involve the input support framework accurately recognizing to which application a user's activity corresponds and then routing the interaction data 950 to only the right application. An application may leverage multiple processes for hosting different user interface elements (e.g., using an out-of-process photo picker) for various reasons (e.g., privacy). The input support framework may accurately recognize to which process a user's activity corresponds and route the interaction data 950 to only the right process. The input support framework may use details about the UIs of multiple, potential target applications and/or processes to disambiguate input.

FIG. 10 illustrates an example of configuring and displaying a control interface for a user interface element that may be controlled by user interaction. In this example, sensor data on device 105 and/or user interface information are used to recognize a user interaction made by user 102, e.g., based on outward-facing image sensor data, depth sensor data, eye sensor data, motion sensor data, etc. and/or information made available by an application providing the user interface. Sensor data may be monitored to detect user activity corresponding to an engagement condition corresponding to the start of a user interaction.

In this example, at block 1010, the process presents a 3D environment (e.g., an XR environment) that includes a view of a user interface 1000 that includes virtual elements/objects. At block 1020, the process obtained user interface element data of the user interface elements (e.g., user interface 1000). In this example, the process determines that user interface 1000 is webpage that displays one or more videos (e.g., user interface 530 of FIG. 5, 7A, and 7B).

At block 1030 the process may receive viewer position data (e.g., head pose data) and/or gaze information (e.g., gaze direction 1005 of user 102). At block 1030, the process may further receive other user activity data such as hands data. The viewer position data may be used to determine which user interface the user may be interacting with (e.g., FIG. 5 displays three different user interfaces 510, 520, 530), so the system may only want to configure a control interface for the user interface the user is directing his or her attention to. Alternatively, the system may configure a control interface for some or all of the user interfaces irrespective of user attention or interaction.

At block 1040, the process configures a control interface based on the user interface the user may be looking at. In this example, the process identifies that the gaze direction 1005 of user 102 is directed towards user interface 1000 and then configures an interface (e.g., a contextual interface) for display proximate to the user interface element and providing controls for controlling functionality made available for interacting with the user interface element within the 3D environment, wherein the interface is configured based on the viewpoint position and the first data. For example, based on the type of image associated with the user interface, the contextual interface may be updated accordingly (e.g., an index, a video controller, panoramic shape, stereo, and the like).

At block 1050, the process displays a control interface (e.g., a contextual interface). In other words, the process generates the contextual interface 1015 that is configured based on one or more attributes associated with the user interface 1000. In this example, the contextual interface 1015 provides the user with video controls to control a currently playing video on the user interface 1000 (e.g., video controls associated with the contextual interface 710 of FIGS. 7A/7B.

In an exemplary implementation, the process at block 1050 may detect that the user 102 has positioned a hand 1022 within view of outward facing image sensors in order to interact with the controls of the contextual interface 1015. In some implementations, the process may detect one or more particular one-handed or two-handed configurations, e.g., a claw shape, a pinch, a point, a flat hand, a steady hand in any configuration, etc., as an indication of hand engagement or may simply detect the presence of the hand within sensor view to initiate a process. Furthermore, at block 1050, the process may recognize a gesture to be associated with the control interface and may control content associated with the control (or initiate an application associated with the object) based on the pose(s) of hand 1022. In this example, the user 102 is gazing at contextual interface 1015 while making a pinching gesture by hand 1022, which may be interpreted to initiate an action upon the contextual interface 1015, e.g., causing a selection action that is analogous to a “click” event of a traditional user interface icon during which a cursor is positioned on an icon and a trigger such as a mouse click or track pad tap is received or similarly analogous to a touch screen “tap” event.

In some implementations, the application that provided the user interface information need not be notified of the hover state and associated feedback. Instead, the hand engagement, object identification, and display of feedback can be handled out of a process (e.g., outside of the application process), e.g., by the operating system processes. For example, such processes may be provided via an operating system's input support process. Doing so may reduce or minimize potentially sensitive user information (e.g., such as constant gaze direction vectors or hand motion direction vectors) that might otherwise be provided to application to enable the application to handle these functions within the application process. Whether and how to display feedback may be specified by the application even though it is carried out of a process. For example, the application may define that an element should display hover or highlight feedback and define how the hover or highlight will appear such that the out of process aspect (e.g., operating system) may provide the hover or highlight according to the defined appearance. Alternatively, feedback can be defined out-of-process (e.g., solely by the OS) or defined to use a default appearance/animation if the application does not specify an appearance.

Recognition of such an interaction with a user interface element may be based on functions performed both via a system process and via an application process. For example, an OS's input process may interpret hands and optionally gaze data from the device's sensors to identify an interaction event and provide limited or interpreted/abstracted information about the interaction event to the application that provided the user interface 1000. For example, rather than providing gaze direction information identifying gaze direction 1005, the OS input support process may identify a 2D point within the 2D user interface 1000 on the contextual interface 1015, e.g., an interaction pose. The application process can then interpret this 2D point information (e.g., interpreting it as a selection, mouse-click, touch-screen tap, or other input received at that point) and provide a response, e.g., modifying its user interface accordingly.

FIG. 10 illustrates examples of recognizing indirect user interactions in order to determine whether or not to display graphical indications as feedback (e.g., hover). Numerous other types of indirect interactions can be recognized, e.g., based on one or more user actions identifying a user interface element and/or one or more user actions providing input (e.g., no-action/hover type input, selection type input, input having a direction, path, speed, acceleration, etc.). Input in 3D space that is analogous to input on 2D interfaces may be recognized, e.g., input analogous to mouse movements, mouse button clicks, touch screen touch events, trackpad events, joystick events, game controller events, etc.

Some implementations utilize an out of process (e.g., outside of an application process) input support framework to facilitate accurate, consistent, and efficient input recognition in a way that preserves private user information. For example, aspects of the input recognition process may be performed out of process such that applications have little or no access to information about where a user is looking, e.g., gaze directions. In some implementations, application access to some user activity information (e.g., gaze direction-based data) is limited to only a particular type of user activity, e.g., activity satisfying particular criteria. For example, applications may be limited to receive only information associated with deliberate or intentional user activity, e.g., deliberate or intentional actions indicative of an intention to interact with (e.g., select, activate, move, etc.) a user interface element.

Some implementations recognize input using functional elements performed both via an application process and a system process that is outside of the application process. Thus, in contrast to a framework in which all (or most) input recognition functions are managed within an application process, some algorithms involved in the input recognition may be moved out of process, e.g., outside of the application process. For example, this may involve moving algorithms that detect gaze input and intent out of an application's process such that the application does not have access to user activity data corresponding to where a user is looking or only has access to such information in certain circumstances, e.g., only for specific instances during which the user exhibits an intent to interact with a user interface element.

Some implementations recognize input using a model in which an application declares or otherwise provides information about its user interface elements so that a system process that is outside of the application process can better facilitate input recognition. For example, an application may declare the locations and/or user interface behaviors/capabilities of its buttons, scroll bars, menus, objects, and other user interface elements. Such declarations may identify how a user interface should behave given different types of user activity, e.g., this button should (or should not) exhibit hover feedback when the user looks at it.

The system process (e.g., outside of the application process) may use such information to provide the desired user interface behavior (e.g., providing hover feedback with a graphical indication in appropriate user activity circumstances). For example, the system process may trigger the graphical indication (hover feedback) for a user interface element based on a declaration from the application that the app's user interface includes the element and that it should display hover feedback, e.g., when gazed upon. The system process may provide such hover feedback based on recognizing the triggering user activity (e.g., gaze at the user interface object) and may do so without revealing to the application the user activity details associated with the user activity that triggered the hover, the occurrence of the user activity that triggered the hover feedback, and/or that the hover feedback was provided. The application may be unaware of the user's gaze direction and/or that hover feedback was provided for the user interface element.

Some aspects of input recognition may be handled by the application itself, e.g., in process. However, the system process may filter, abstract, or otherwise manage the information that is made available to the application to recognize input to the application. The system process may do so in ways that facilitate input recognition that is efficient, accurate, consistent (within the application and across multiple applications), and that allow the application to potentially use easier-to-implement input recognition and/or legacy input recognition processes, such as input recognition processes developed for different systems or input environment, e.g., using touch screen input processes used in legacy mobile applications.

Some implementations, use a system process to provide interaction event data to applications to enable the applications to recognize input. The interaction event data may be limited so that all user activity data is not available to the applications. Providing only limited user activity information may help protect user privacy. The interaction event data may be configured to correspond to events that can be recognized by the application using a general or legacy recognition process. For example, a system process may interpret 3D user activity data to provide interaction event data to an application that the application can recognize in the same way that the application would recognize a touch event on a touch screen. In some implementations, an application receives interaction event data corresponding to only certain types of user activity, e.g., intentional, or deliberate actions on user interface objects, and may not receive information about other types of user activity, e.g., gaze only activities, a user moving their hands in ways not associated with user interface interactions, a user moving closer to or further away from the user interface, etc. In one example, during a period of time (e.g., a minute, 10 minutes, etc.) a user gazes around a 3D XR environment including gazes at certain user interface text, buttons, and other user interface elements and eventually performs an intentional user interface interaction, e.g., by making an intentional pinch gesture while gazing at button X. A system process may handle all of the user interface feedback during the gazing around at the various user interface elements without providing the application information about these gazes. On the other hand, the system process may provide interaction event data to the application based on the intentional pinch gesture while gazing at button X. However, even this interaction event data may provide limited information to the application, e.g., providing an interaction position or pose identifying an interaction point on button X without providing information about the actual gaze direction. The application can then interpret this interaction point as an interaction with the button X and respond accordingly. Thus, user behavior that is not associated with intentional user interactions with user interface elements (e.g., gaze only hover, menu expansion, reading, etc.) are handled out of process without the application having access to user data and the information about the intentional user interface element interactions is limited such that it does not include all of the user activity details.

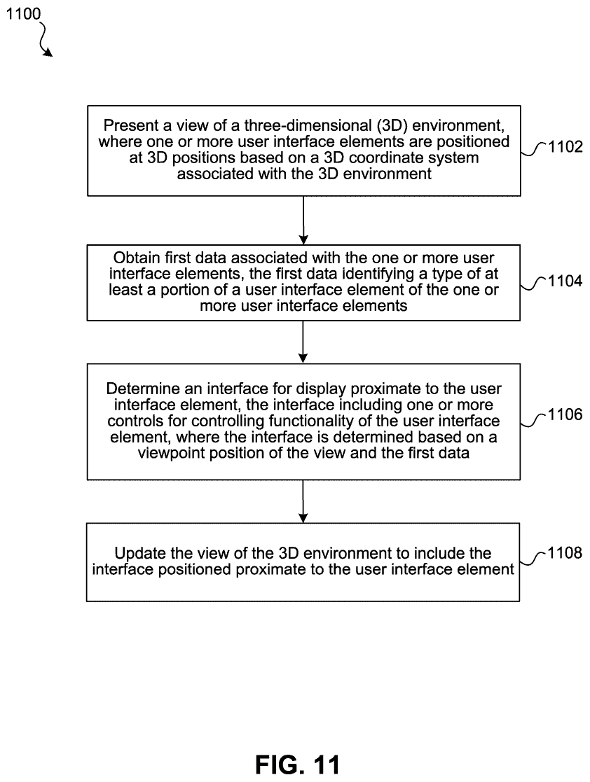

FIG. 11 is a flowchart illustrating a method 1100 for providing an interface positioned on a surface of a user interface element that includes controls for controlling functionality of the user interface element, in accordance with some implementations. In some implementations, a device such as electronic device 105 or electronic device 110 performs method 1100. In some implementations, method 1100 is performed on a mobile device, desktop, laptop, HMD, or server device. The method 1100 is performed by processing logic, including hardware, firmware, software, or a combination thereof. In some implementations, the method 1100 is performed on a processor executing code stored in a non-transitory computer-readable medium (e.g., a memory).

Various implementations of the method 1100 disclosed herein generates and displays a customized contextual interface (e.g., a control window) on a two-dimensional (2D) webpage viewed in an XR environment using a 3D display device (e.g., a wearable device such as a head-mounted device (HMD)). For example, the contextual interface may present controls and information related to a window, without crowding or obscuring the window's contents. The contextual interface may be interacted with based on a user's intent (attention) directed at the interface. The goal is to provide easier-to-use virtual controls for a 2D webpage when displayed in a 3D environment. Various implementations of method 1100 may customize and/or update the contextual interface (e.g., a control window) based on graphical display data associated with the 2D webpage. For example, if the user is watching a webpage that displays several videos, a media player interface may be presented to the user. If the user is browsing a webpage that displays several different pages of text displays, an information interface may be displayed that lets a user navigate to various portions of the page (e.g., a quick link table of contents).

At block 1102, the method 1100 presents a view of a 3D environment, where one or more user interface elements are positioned at 3D positions based on a 3D coordinate system associated with the 3D environment. For example, as illustrated in FIG. 2, a 2D webpage (e.g., user interface 230) may be viewed using a 3D device (e.g., device 105). In some implementations, at an input support process, the process includes obtaining data corresponding to positioning of user interface elements of the application within a 3D coordinate system. The data may correspond to the positioning of the user interface element based at least in part on data (e.g., positions/shapes of 2D elements intended for a 2D window area) provided by the application, for example, such as user interface information provided from an application to operating system process. In some implementations, the operating system manages information about a virtual and/or real content positioned within a 3D coordinate system. Such a 3D coordinate system may correspond to an XR environment representing the physical environment and/or virtual content corresponding to content from one or more applications. The executing application may provide information about the positioning of its user interface elements via a layered tree (e.g., a declarative, hierarchical layer tree) with some layers identified for remote (i.e., out of app process) input effects.

At block 1104, the method 1100 obtains first data associated with the one or more user interface elements, the first data identifying a type of at least a portion of a user interface element of the one or more user interface elements. For example, obtain source data of a 2D webpage and/or use machine learning to understand a type of page/content (e.g., a type, a category, source, etc.) and to segment the webpage into meaningful categories. For example, as illustrated FIG. 6A, the contextual interface 610 provides an index interface 612 (e.g., an interactable element that lists determined subcategories of the content associated with the user interface 510).

In some implementations, obtaining the first data associated with the one or more user interface elements includes determining a type of content associated with each user interface element of the one or more user interface elements, and determining a category for each user interface element based on the determined type of content associated with each user interface element, wherein the interface is determined based on the determined category for the first data. In some implementations, determining the type of content associated with each user interface element is based on using a machine learning classifier model to identify one or more types of content associated with each user interface element. For example, obtain source data of a 2D webpage and/or use machine learning to understand a type of page/content (e.g., a type, a category, source, etc.) and to segment the webpage into meaningful categories, and update (e.g., match) the interface and/or the controls of the interface based on the determined categories.

At block 1106, the method 1100 determines an interface (e.g., a contextual interface) for display proximate to the user interface element, the interface including one or more controls for controlling functionality of the user interface element, where the interface is determined based on a viewpoint position of the view and the first data. For example, based on the type of image associated with the user interface, the contextual interface may be updated accordingly (e.g., an index, a video controller, panoramic shape, stereo, and the like).

In some implementations, the method 1100 obtains viewer position data corresponding to a viewpoint position for the view within the 3D environment. In some implementations, the viewer position data corresponding to the viewpoint position includes a pose of the device or a head of a user wearing the device. In some implementations, the viewer position data corresponding to the viewpoint position includes six degrees of freedom (6DOF) position data (e.g., 6DOF pose of the user). For example, as illustrated in FIG. 4, the user's 102 viewpoint position and central focus is illustrated by gaze path 410, where the gaze direction focal point of the user 102 is detected towards the user interface element 246 (e.g., the focus of the user 102 as he or she is focused on a particular portion of the user interface 400, such as reading text, watching a video, etc.).

In some implementations, the interface (e.g., a contextual interface) includes one or more control elements that enable control of one or more portions of the user interface element. For example, as illustrated by FIG. 7A, the contextual interface 710 (e.g., a control window) includes control elements that are able to interact with the current webpage such as user interface 530 (e.g., a webpage of several videos with a main portion that includes a video player). In some implementations, the interface is anchored to the surface the user interface element. For example, the contextual interface is attached to the same location on the webpage (e.g., bottom center), such that if the user spatially moves the 2D webpage to another 3D coordinate position within the current view, the contextual interface is anchored to the same position and moves with the webpage.

At block 1108, the method 1100 updates the view of the 3D environment to include the interface positioned proximate to the user interface element. In some implementations, the interface may be positioned on a surface (e.g., a flat/2D surface) of the user interface element. Additionally, or alternatively, in some implementations, the interface may be positioned in front of, next to, or somewhere else proximate to the user interface element. For example, as illustrated by FIG. 8B, the contextual interface 810 is generated that appears to be in a panoramic shape, the same shape as the panoramic video being played by user interface 820, and the contextual interface 810 is displayed in front of the user interface 820.

In some implementations, the method 1100 further includes determining one or more attributes associated with the user interface element, wherein determining the interface includes determining one or more attributes associated with the interface based on the determined one or more attributes associated with the user interface element. For example, rather than take a predefined shape, the contextual interface may have a border/shape that matches that of the webpage. Similarly, the contextual interface may match other attributes of the webpage, such as color. For example, for FIG. 8B, if the outside border of the video player for the user interface 820 displayed a video effect such as a color matching glow that surrounds the video, then the contextual interface 810 may match the color matching glow and also display a similar glow around the border of the contextual interface 810.

In some implementations, the at least a portion of the user interface element includes a panoramic image, the type of the at least a portion of the user interface element is a panoramic image type, and the interface is determined based on the panoramic image type. For example, as illustrated by FIG. 8B, the contextual interface 810 is generated that appears to be in a panoramic shape, the same shape as the panoramic video being played by user interface 820. In some implementations, the at least a portion of the user interface element includes stereoscopic image pairs including left eye content corresponding to a left eye viewpoint and right eye content corresponding to a right eye viewpoint, the type of the at least a portion of the user interface element is a stereoscopic image type, and the interface is determined based on the stereoscopic image type. Thus, if the user interface 820 converts from the panoramic display to a stereo display and a flat rectangle shape, then the contextual interface 810 may update to match as a stereo display control window and in a flat rectangle shape, and may still be anchored in the same location (e.g., bottom and centered).

In some implementations, the method 1100 further includes removing the interface from the view of the 3D environment in response to determining that the user interface element includes control elements that satisfy one or more criterion. For example, if a currently playing video of the video content 730 of FIG. 7A/7B ceases to be displayed (e.g., the video ends so the video player window closes), then the contextual interface 710 would also disappear. Additionally, or alternatively, the method 1100 may determine that the controls of the video content 730 have changed size and are determined to be large enough for gaze control, then the contextual interface 710 may also disappear. In other words, the system determines whether or not to display the contextual interface 710 to control the video content 730 based on a size threshold associated with the controls of the video content 730. In other words, if the controls are determined to be too small because the video player is displayed as a small portion in the webpage and relative to a current view, then the contextual interface 710 may be automatically displayed to aide in controlling the video, and vice versa, if the controls are determined to be large enough to control with gaze relative to the current view, then the contextual interface 710 may be automatically removed from view.

In some implementations, the method 1100 further includes receiving data corresponding to user activity associated with the one or more controls of the interface and updating the user interface element based on the user activity. For example, user activity data may include hands data and gaze data, or data corresponding to other input modalities (e.g., an input controller). As described with respect to FIG. 10, such data may include but is not limited to including hands data, gaze data, and/or human interface device (HID) data. A single type of data or various combinations of two or more different types of data may be received, e.g., hands data and gaze data, controller data and gaze data, hands data and controller data, voice data and gaze data, voice data and hands data, etc. Different combinations of sensor/HID data may correspond to different input modalities. In one exemplary implementation, the data includes both hands data (e.g., a hand pose skeleton identifying 20+ joint locations) and gaze data (e.g., a stream of gaze vectors), and both the hands data and gaze data may both be relevant to recognizing input via a direct touch input modality and an indirect touch input modality.

In some implementations, the method 1100 identifies a user interaction event associated with a first user interface element in the 3D environment based on the data corresponding to the user activity. For example, a user interaction event may be based on determining whether a user is focused (attentive) towards a particular object (e.g., a user interface element—such as a contextual interface) using gaze and/or pinch data based on the direction of eye gaze, head, hand, arm, etc. In some implementations, identifying the user interaction event may be based on determining that a pupillary response corresponds to directing attention to a region associated with the user interface element (e.g., a control button on a contextual interface such as play, stop, fast forward, etc.). In some implementations, identifying the user interaction event may be based on a finger point and hand movement gesture. In some implementations, the user interaction event is based on a direction of a gaze or a face of a user with respect to the contextual interface or other user interface element. The direction of a face of a user with respect to the user interface may be determined by extending a ray from a position on the face of the user and determining that the ray intersects the visual element on the user interface.

In some implementations, the interaction event data may include an interaction pose (e.g., 6DOF data for a point on the app's user interface), a manipulator pose (e.g., 3D location of the stable hand center or pinch centroid), an interaction state (e.g., direct, indirect, hover, pinch, etc.) and/or identify which user interface element is being interacted with. In some implementations, the interaction data may exclude data associated with user activity occurring between intentional events. The interaction event data may exclude detailed sensor/HID data such as hand skeleton data. The interaction event data may abstract detailed sensor/HID data to avoid providing data to the application that is unnecessary for the application to recognize inputs and potentially private to the user.

In some implementations, the method 1100 may display a view of an extended reality (XR) environment corresponding to the (3D) coordinate system, where the user interface elements of the application are displayed in the view of the XR environment.

Such an XR environment may include user interface elements from multiple application processes corresponding to multiple applications and the input support process may identify the interaction event data for the multiple applications and route interaction event data to only the appropriate applications, e.g., the applications to which the interactions are intended by the user. Accurately routing data to only the intended applications may help ensure that one application does to misuse input data intended for another application (e.g., one application does not track a user entering a password into another application).

In some implementations, the data corresponding to the user activity may have various formats and be based on or include (without being limited to being based on or including) sensor data (e.g., hands data, gaze data, head pose data, etc.) or HID data. In some implementations, the data corresponding to the user activity includes gaze data including a stream of gaze vectors corresponding to gaze directions over time during use of the electronic device. The data corresponding to the user activity may include hands data including a hand pose skeleton of multiple joints for each of multiple instants in time during use of the electronic device. The data corresponding to the user activity may include both hands data and gaze data. The data corresponding to the user activity may include controller data and gaze data. The data corresponding to the user activity may include, but is not limited to, any combination of data of one or more types, associated with one or more sensors or one or more sensor types, associated with one or more input modalities, associated with one or more parts of a user (e.g., eyes, nose, cheeks, mouth, hands, fingers, arms, torso, etc.) or the entire user, and/or associated with one or more items worn or held by the user (e.g., mobile devices, tablets, laptops, laser pointers, hand-held controllers, wands, rings, watches, bracelets, necklaces, etc.).

In some implementations, the method 1100 further includes identifying the interaction event data for the application and may involve identifying only certain types of activity within the user activity to be included in the interaction event data. In some implementations, activity (e.g., types of activity) of the user activity that is determined to correspond to unintentional events rather than intentional user interface element input is excluded from the interaction event data. In some implementations, passive gaze-only activity of the user activity is excluded from the interaction event data. Such passive gaze-only behavior (not intentional input) is distinguished from intentional gaze-only interactions (e.g., gaze dwell, or performing a gaze up to the sky gesture to invoke/dismiss the gaze HUD, etc.).

Identifying the interaction event data for the application may involve identifying only certain attributes of the data corresponding to the user activity for inclusion in the interaction event data, e.g., including a hand center rather than the positions of all joints used to model a hand, including a single gaze direction or a single HID pointing direction for a given interaction event. In another example, a start location of a gaze direction/HID pointing direction is changed or withheld, e.g., to obscure data indicative of how far the user is from the user interface or where the user is in the 3D environment. In some implementations, the data corresponding to the user activity includes hands data representing the positions of multiple joints of a hand and the interaction event data includes a single hand pose that is provided instead of the hands data.

In some implementations, the method 1100 is performed by an electronic device that is an HMD and/or the XR environment is a virtual reality environment or an augmented reality environment.

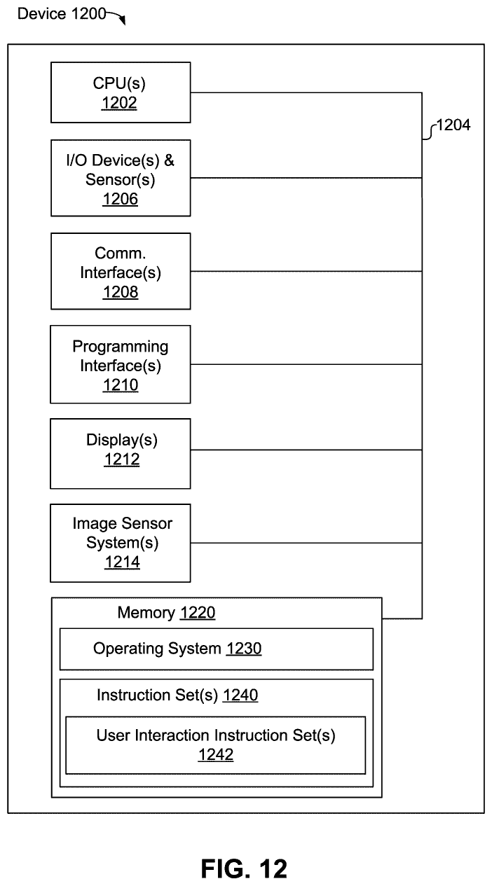

FIG. 12 is a block diagram of electronic device 1200. Device 1200 illustrates an exemplary device configuration for electronic device 110 or electronic device 105. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1200 includes one or more processing units 1202 (e.g., microprocessors, ASICs, FPGAs, GPUS, CPUs, processing cores, and/or the like), one or more input/output (I/O) devices and sensors 1206, one or more communication interfaces 1208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 1210, one or more output device(s) 1212, one or more interior and/or exterior facing image sensor systems 1214, a memory 1220, and one or more communication buses 1204 for interconnecting these and various other components.

In some implementations, the one or more communication buses 1204 include circuitry that interconnects and controls communications between system components. In some implementations, the one or more I/O devices and sensors 1206 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 1212 include one or more displays configured to present a view of a 3D environment to the user. In some implementations, the one or more output device(s) 1212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 1200 includes a single display. In another example, the device 1200 includes a display for each eye of the user.

In some implementations, the one or more output device(s) 1212 include one or more audio producing devices. In some implementations, the one or more output device(s) 1212 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 1212 may additionally or alternatively be configured to generate haptics.

In some implementations, the one or more image sensor systems 1214 are configured to obtain image data that corresponds to at least a portion of a physical environment. For example, the one or more image sensor systems 1214 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 1214 further include illumination sources that emit light, such as a flash. In various implementations, the one or more image sensor systems 1214 further include an on-camera image signal processor (ISP) configured to execute a plurality of processing operations on the image data.

The memory 1220 includes high-speed random-access memory, such as DRAM, SRAM, DDR RAM, or other random-access solid-state memory devices. In some implementations, the memory 1220 includes non-volatile memory, such as one or more magnetic disk storage devices, optical disk storage devices, flash memory devices, or other non-volatile solid-state storage devices. The memory 1220 optionally includes one or more storage devices remotely located from the one or more processing units 1202. The memory 1220 includes a non-transitory computer readable storage medium.

In some implementations, the memory 1220 or the non-transitory computer readable storage medium of the memory 1220 stores an optional operating system 1230 and one or more instruction set(s) 1240. The operating system 1230 includes procedures for handling various basic system services and for performing hardware dependent tasks. In some implementations, the instruction set(s) 1240 include executable software defined by binary information stored in the form of electrical charge. In some implementations, the instruction set(s) 1240 are software that is executable by the one or more processing units 1202 to carry out one or more of the techniques described herein.

The instruction set(s) 1240 include user interaction instruction set(s) 1242 configured to, upon execution, identify and/or interpret user gestures and other user activities as described herein. The instruction set(s) 1240 include application instruction set(s) 1242 for one or more applications. In some implementations, each of the applications is provided for as a separately-executing set of code, e.g., capable of being executed via an application process. The instruction set(s) 1240 may be embodied as a single software executable or multiple software executables.

Although the instruction set(s) 1240 are shown as residing on a single device, it should be understood that in other implementations, any combination of the elements may be located in separate computing devices. Moreover, the figure is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

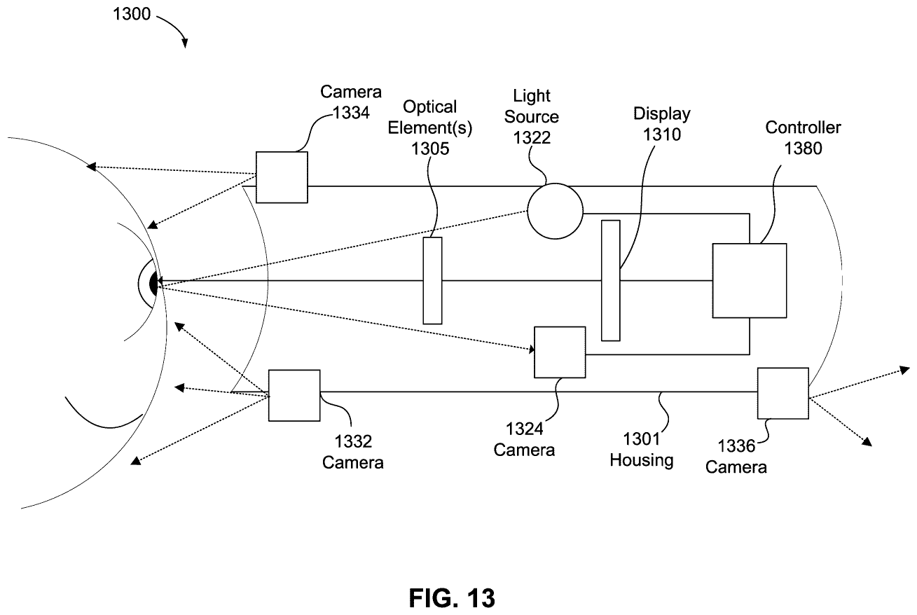

FIG. 13 illustrates a block diagram of an exemplary head-mounted device 1300 in accordance with some implementations. The head-mounted device 1300 includes a housing 1301 (or enclosure) that houses various components of the head-mounted device 1300. The housing 1301 includes (or is coupled to) an eye pad (not shown) disposed at a proximal (to the user 102) end of the housing 1301. In various implementations, the eye pad is a plastic or rubber piece that comfortably and snugly keeps the head-mounted device 1300 in the proper position on the face of the user 102 (e.g., surrounding the eye of the user 102).

The housing 1301 houses a display 1310 that displays an image, emitting light towards or onto the eye of a user 102. In various implementations, the display 1310 emits the light through an eyepiece having one or more optical elements 1305 that refracts the light emitted by the display 1310, making the display appear to the user 102 to be at a virtual distance farther than the actual distance from the eye to the display 1310. For example, optical element(s) 1305 may include one or more lenses, a waveguide, other diffraction optical elements (DOE), and the like. For the user 102 to be able to focus on the display 1310, in various implementations, the virtual distance is at least greater than a minimum focal distance of the eye (e.g., 7 cm). Further, in order to provide a better user experience, in various implementations, the virtual distance is greater than 1 meter.

The housing 1301 also houses a tracking system including one or more light sources 1322, camera 1324, camera 1332, camera 1334, camera 1336, and a controller 1380. The one or more light sources 1322 emit light onto the eye of the user 102 that reflects as a light pattern (e.g., a circle of glints) that may be detected by the camera 1324. Based on the light pattern, the controller 1380 may determine an eye tracking characteristic of the user 102. For example, the controller 1380 may determine a gaze direction and/or a blinking state (eyes open or eyes closed) of the user 102. As another example, the controller 1380 may determine a pupil center, a pupil size, or a point of regard. Thus, in various implementations, the light is emitted by the one or more light sources 1322, reflects off the eye of the user 102, and is detected by the camera 1324. In various implementations, the light from the eye of the user 102 is reflected off a hot mirror or passed through an eyepiece before reaching the camera 1324.

The display 1310 emits light in a first wavelength range and the one or more light sources 1322 emit light in a second wavelength range. Similarly, the camera 1324 detects light in the second wavelength range. In various implementations, the first wavelength range is a visible wavelength range (e.g., a wavelength range within the visible spectrum of approximately 400-700 nm) and the second wavelength range is a near-infrared wavelength range (e.g., a wavelength range within the near-infrared spectrum of approximately 700-1400 nm).

In various implementations, eye tracking (or, in particular, a determined gaze direction) is used to enable user interaction (e.g., the user 102 selects an option on the display 1310 by looking at it), provide foveated rendering (e.g., present a higher resolution in an area of the display 1310 the user 102 is looking at and a lower resolution elsewhere on the display 1310), or correct distortions (e.g., for images to be provided on the display 1310).

In various implementations, the one or more light sources 1322 emit light towards the eye of the user 102 which reflects in the form of a plurality of glints.

In various implementations, the camera 1324 is a frame/shutter-based camera that, at a particular point in time or multiple points in time at a frame rate, generates an image of the eye of the user 102. Each image includes a matrix of pixel values corresponding to pixels of the image which correspond to locations of a matrix of light sensors of the camera. In implementations, each image is used to measure or track pupil dilation by measuring a change of the pixel intensities associated with one or both of a user's pupils.

In various implementations, the camera 1324 is an event camera including a plurality of light sensors (e.g., a matrix of light sensors) at a plurality of respective locations that, in response to a particular light sensor detecting a change in intensity of light, generates an event message indicating a particular location of the particular light sensor.

In various implementations, the camera 1332, camera 1334, and camera 1336 are frame/shutter-based cameras that, at a particular point in time or multiple points in time at a frame rate, may generate an image of the face of the user 102 or capture an external physical environment. For example, camera 1332 captures images of the user's face below the eyes, camera 1334 captures images of the user's face above the eyes, and camera 1336 captures the external environment of the user (e.g., environment 100 of FIG. 1). The images captured by camera 1332, camera 1334, and camera 1336 may include light intensity images (e.g., RGB) and/or depth image data (e.g., Time-of-Flight, infrared, etc.).

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at an electronic device having a processor:
presenting a view of a three-dimensional (3D) environment, wherein one or more user interface elements are positioned at 3D positions based on a 3D coordinate system associated with the 3D environment;
obtaining first data associated with the one or more user interface elements, the first data identifying a type of at least a portion of a user interface element of the one or more user interface elements;
determining an interface for display proximate to the user interface element, the interface comprising one or more controls for controlling functionality of the user interface element, wherein the interface is determined based on a viewpoint position of the view and the first data; and
updating the view of the 3D environment to include the interface positioned proximate to the user interface element.

2. The method of claim 1, wherein the one or more controls enable control of one or more portions of the user interface element.

3. The method of claim 1, wherein the interface is anchored to a surface of the user interface element.

4. The method of claim 1, wherein:
the at least a portion of the user interface element comprises a panoramic image;
the type of the at least a portion of the user interface element is a panoramic image type; and
the interface is determined based on the panoramic image type.

5. The method of claim 1, wherein:
the at least a portion of the user interface element comprises stereoscopic image pairs comprising left eye content corresponding to a left eye viewpoint and right eye content corresponding to a right eye viewpoint;
the type of the at least a portion of the user interface element is a stereoscopic image type; and
the interface is determined based on the stereoscopic image type.

6. The method of claim 1, further comprising:
determining one or more attributes associated with the user interface element, wherein determining the interface comprises determining one or more attributes associated with the interface based on the determined one or more attributes associated with the user interface element.

7. The method of claim 1, wherein obtaining the first data associated with the one or more user interface elements comprises:
determining a type of content associated with each user interface element of the one or more user interface elements; and
determining a category for each user interface element based on the determined type of content associated with each user interface element, wherein the interface is determined based on the determined category for the first data.

8. The method of claim 7, wherein determining the type of content associated with each user interface element is based on using a machine learning classifier model to identify one or more types of content associated with each user interface element and segment the one or more types of content to an associated category.

9. The method of claim 1, further comprising:
removing the interface from the view of the 3D environment in response to determining that the user interface element comprises control elements that satisfy one or more criterion.

10. The method of claim 1, further comprising:
receiving data corresponding to user activity associated with the one or more controls of the interface; and updating the user interface element based on the user activity.

11. The method of claim 10, wherein the data corresponding to the user activity is obtained via one or more sensors on the electronic device.

12. The method of claim 10, wherein the data corresponding to the user activity comprises gaze data comprising a stream of gaze vectors corresponding to gaze directions over time during use of the electronic device.

13. The method of claim 10, wherein the data corresponding to the user activity comprises hands data comprising a hand pose skeleton of multiple joints for each of multiple instants in time during use of the electronic device.

14. The method of claim 10, wherein the data corresponding to the user activity comprises hands data and gaze data.

15. The method of claim 1, wherein the 3D environment is an extended reality (XR) environment.

16. The method of claim 1, wherein the electronic device is a head-mounted device (HMD).

17. A device comprising:
a non-transitory computer-readable storage medium; and
one or more processors coupled to the non-transitory computer-readable storage medium, wherein the non-transitory computer-readable storage medium comprises program instructions that, when executed on the one or more processors, cause the one or more processors to perform operations comprising:
presenting a view of a three-dimensional (3D) environment, wherein one or more user interface elements are positioned at 3D positions based on a 3D coordinate system associated with the 3D environment;
obtaining first data associated with the one or more user interface elements, the first data identifying a type of at least a portion of a user interface element of the one or more user interface elements;
determining an interface for display proximate to the user interface element, the interface comprising one or more controls for controlling functionality of the user interface element, wherein the interface is determined based on a viewpoint position of the view and the first data; and
updating the view of the 3D environment to include the interface positioned proximate to the user interface element.

18. The device of claim 17, wherein the one or more controls enable control of one or more portions of the user interface element.

19. The device of claim 17, wherein the interface is anchored to a surface of the user interface element.

20. A non-transitory computer-readable storage medium, storing program instructions executable on a device to perform operations comprising:
presenting a view of a three-dimensional (3D) environment, wherein one or more user interface elements are positioned at 3D positions based on a 3D coordinate system associated with the 3D environment;
obtaining first data associated with the one or more user interface elements, the first data identifying a type of at least a portion of a user interface element of the one or more user interface elements;
determining an interface for display proximate to the user interface element, the interface comprising one or more controls for controlling functionality of the user interface element, wherein the interface is determined based on a viewpoint position of the view and the first data; and
updating the view of the 3D environment to include the interface positioned proximate to the user interface element.
